(19) United States
(12) Patent Application Publication
(10) Pub. No.: US 2010/0244779 A1
(43) Pub. Date: Sep. 30, 2010

(54) CHARGING CONTROL DEVICE AND ELECTRONIC APPARATUS USING SAME

(75) Inventor: Hideo Hara, Osaka (JP)

Correspondence Address: FISH & RICHARDSON P.C., P.O. BOX 1022, MINNEAPOLIS, MN, 55440-1022, US

(73) Assignee: Rohm Co., Ltd., Kyoto (JP)

(21) Appl. No.: 12/680,222

(22) PCT Filed: Sep. 30, 2008
(86) PCT No.: PCT/JP2008/067711

§ 371 Date: Mar. 26, 2010

(30) Foreign Application Priority Data
Oct. 4, 2007 (JP) 2007-260814
Oct. 4, 2007 (JP) 2007-260816

(51) Int. Cl. H02J 7/04

(52) U.S. Cl. 320/152; 320/162

(57) ABSTRACT

A charging control device (1) of the present invention monitors a charging current (I3) for a secondary battery (3) and controls the charging of the secondary battery (3) such that the current value of the charging current is equal to which of a target value preset within the device and a target value freely set from an outside of the device is smaller.

### TECHNICAL FIELD

The present invention relates to a charging control device that controls the charging of a secondary battery (for example, a lithium ion battery) and an electronic apparatus incorporating such a charging control device.

### BACKGROUND ART

### Background Art for Charging Control Devices

Most electronic apparatuses incorporating a secondary battery (for example, a lithium ion battery) as a power supply, such as potable navigation devices (PND) and mobile telephones, include a charging control device (power management IC) that receives electric power from a host machine (USB host) connected to a USB (universal serial bus) port or a power supply adapter and that controls the charging of the secondary battery.

In particular, when a lithium ion battery is used as a secondary battery, it is necessary to accurately control the charging current therefor, and thus, in a conventional charging control device, an ambient temperature and a consumption current (current used for operations other than the charging) for a system are monitored, and a target value of the charging current is set according to the result of the monitoring (internal control). On the other hand, when power is received from a power supply adapter to charge the secondary battery, a target value of the charging current is set by using an external resistor (external control).

As an example of a conventional technology related to the foregoing, the invention disclosed in patent document 1 can be taken.

As examples of a conventional technology related to a temperature detection circuit, patent documents 2 and 3 and the like of the applicant of the present invention can be taken.

### Background Art for Back Gate Control Circuits

Conventionally, in power supply circuits, a switch circuit formed with a field-effect transistor is connected between an input terminal into which an input voltage is applied and an output terminal from which an output voltage is output, and, with the switch circuit, the control of the switching between a main battery and a backup battery and the control of the stepping up of the input voltage are generally performed.

Incidentally, when the field-effect transistor that forms the switch circuit is integrated into a semiconductor device, the parasitic diode of a PN junction is generally formed between the back gate and the source and drain of the field-effect transistor. Hence, when the input voltage is interrupted, the parasitic diode can behave as a path through which a current leaks from the output terminal (backup battery or output capacitor) to the input terminal.

Thus, in the conventional power supply circuit, a back gate switching circuit is used which switches between units connected thereto such that the back gate of the field-effect transistor of the switch circuit reaches the maximum potential point within the system, with the result that, even when the input voltage is interrupted, the parasitic diode is reverse-biased.

As examples of a conventional technology related to the foregoing, patent documents 4 and 5 of the applicant of the present invention can be taken.

Patent document 1: JP-A-2003-032910

Patent document 2: JP-A-2005-016992

Patent document 3: JP-H09-189614

Patent document 4: JP-A-2003-347913

Patent document 5: JP-A-2002-10525

### DISCLOSURE OF THE INVENTION

### Problems to be Solved by the Invention

<Problems in the Charging Control Device>

To be sure, with the conventional charging control device described above, it is possible to control the charging of the secondary battery by receiving the power from the USB host or the power supply adapter.

In the conventional charging control device, however, the path through which power is supplied from the USB host and the path through which power is supplied from the power supply adapter are formed as different systems, and the target value of the charging current is set differently according to which of the USB host and the power supply adapter is connected as the supply source of the charging current.

Specifically, with reference to the example described previously, when the USB host is connected as the supply source of the charging current, the setting of the target value of the charging current using the external resistor (external control) is not reflected at all, and thus it is impossible for a user to freely set the target value of the charging current.

On the other hand, when the power supply adapter is connected as the supply source of the charging current, it is necessary for the user to set, with consideration given to variations in the ambient temperature and the consumption current of the system and the like, the target value of the charging current such that a sufficient safety margin is included. This is partly responsible for extending the charging time.

<Problems in the Back Gate Control Circuit>

With the conventional power supply circuit, even when the input voltage is interrupted, it is possible to reverse-bias the parasitic diode. Thus, it is possible to prevent the leak current from leaking from the output terminal to the input terminal.

In the conventional technology disclosed in patent document 4, however, the input voltage is assumed to be higher than the output voltage at the time of normal operation, and accordingly the leak current is intended to be prevented when the input voltage is interrupted. This conventional technology is not intended to be applied to a system (for example, the charging control device) where it is not determined which of the source and drain of the field-effect transistor is higher in voltage.

In the conventional technology disclosed in patent document 5, as means for switching the back gate, an NMOS and a PMOS are used, and thus a terminal is needed through which power is constantly supplied to one of them.

In view of the foregoing problems, the present invention has an object to provide a charging control device that safely and optimally can control the charging of a secondary battery and an electronic apparatus incorporating such a charging control device.

### Means for Solving the Problem

To achieve the above object, according to one aspect of the present invention, there is provided a charging control device that monitors a charging current for a secondary battery and that controls charging of the secondary battery such that a current value of the charging current is equal to which of a target value preset within the device and a target value freely set from an outside of the device is smaller (first configuration).

In the charging control device of the first configuration, at least a target value corresponding to an ambient temperature, a target value corresponding to a consumption current of a system and a target value corresponding to a standard of an externally connected power supply source are preset within the device, and the charging of the secondary battery may be controlled such that the current value of the charging current is equal to which of the target values preset within the device and the target value freely set from the outside of the device is the smallest (second configuration).

In the charging control device of the second configuration, the target value corresponding to the ambient temperature may be set such that, as the ambient temperature is higher, the target value corresponding to the ambient temperature is decreased (third configuration).

In the charging control device of the third configuration, a temperature sensor detecting the ambient temperature may include a pair of PNP bipolar transistors that are operated at different emitter current densities, and may produce an oppositely varying temperature detection signal by utilizing the fact that a difference between base-emitter voltages of the transistors varies with the ambient temperature (fourth configuration).

According to another aspect of the present invention, there is provided an electronic apparatus including: the charging control device of any one of the first to fourth configurations; and the secondary battery the charging of which is controlled by the charging control device (fifth configuration).

A back gate switching circuit disclosed in this specification connects the back gate of a field-effect transistor inserted between the first terminal and the second terminal to one of the first terminal and the second terminal. The back gate switching circuit includes: a comparison portion that receives power from the first terminal to become driven, that compares the voltage input to the first terminal with the voltage input to the second terminal, and that produces, when the former is higher than the latter, a high-level comparison signal and produces, when the former is lower than the latter, a low-level comparison signal; an inverter that receives power from the second terminal to become driven, and that inverts the logic state of the comparison signal input from the comparison portion either directly or through a buffer to produce the inverted comparison signal; a first p-channel field-effect transistor that is connected between the back gate of the field-effect transistor and the first terminal and that is turned on and off according to the inverted comparison signal; a second p-channel field-effect transistor that is connected between the back gate of the field-effect transistor and the second terminal and that is turned on and off according to the comparison signal input from the comparison portion either directly or through a buffer; and resistors that pull down the input terminal of the inverter and the gate of the second p-channel field-effect transistor (sixth configuration).

The back gate switching circuit of the sixth configuration may further include: a third p-channel field-effect transistor that is connected between the gate of the field-effect transistor and the first terminal and that is turned on and off according to the inverted comparison signal; and a fourth p-channel field-effect transistor that is connected between the gate of the field-effect transistor and the second terminal and that is turned on and off according to the comparison signal input from the comparison portion either directly or through a buffer (seventh configuration).

The back gate switching circuit of the sixth configuration or the seventh configuration can be suitably used in a system where it is unpredictable which of the source and the drain of the field-effect transistor is high in potential.

A charging control device disclosed in this specification includes: a field-effect transistor that is connected between a first terminal and a second terminal and that is used as means for controlling the charging of a secondary battery; and the back gate switching circuit of the sixth configuration or the seventh configuration, which connects the back gate of the field-effect transistor to one of the first terminal and the second terminal (eighth configuration).

An electronic apparatus disclosed in this specification includes: the charging control device of the eighth configuration; and the secondary battery the charging of which is controlled by the charging control device (ninth configuration).

### ADVANTAGES OF THE INVENTION

According to the present invention, it is possible to safely and optimally control the charging of a secondary battery.

### BRIEF DESCRIPTION OF DRAWINGS

FIG. 1 is a block diagram showing an embodiment of an electronic apparatus incorporating a charging control device according to the present invention;

FIG. 2 is a block diagram for summarizing a charging control operation by a power management IC 1;

FIG. 3A is a diagram for describing only the control of charging corresponding to an ambient temperature;

FIG. 3B is a diagram for describing only the control of charging corresponding to a system current;

FIG. 3C is a diagram for describing only the control of charging corresponding to an internal setting value;

FIG. 3D is a diagram for only describing the control of charging corresponding to an external setting value;

FIG. 4 is a diagram showing an example of the charging control operation by the power management IC 1;

FIG. 5 is a circuit diagram showing an example of the configuration of a temperature sensor 16; and

FIG. 6 is a circuit diagram showing an example of the configuration of a back gate switching circuit 20.

### LIST OF REFERENCE SYMBOLS

1 Power management IC (charging control device)
11 Charging control portion
12 and 13 Amplifier
14 and 15 P-channel field-effect transistor
16 Temperature sensor
17 Internal setting portion
18 External setting portion
19 DC/DC converter
20 Back gate switching circuit
2 Microcomputer
3 Lithium ion battery (secondary battery)
4 and 5 Sense resistor
6 Port
7 Power supply line
8 Signal line
Pa to Pg PNP bipolar transistor
Na and Nb NPN bipolar transistor
Ia and Ib Constant current source
Ra to Rd Resistor
P1 to P4 P-channel field-effect transistor
N1 N-channel field-effect transistor
R1 to R8 Resistor
CMP Comparator
INV Inverter
B1 to B3 Buffer

### BEST MODE FOR CARRYING OUT THE INVENTION

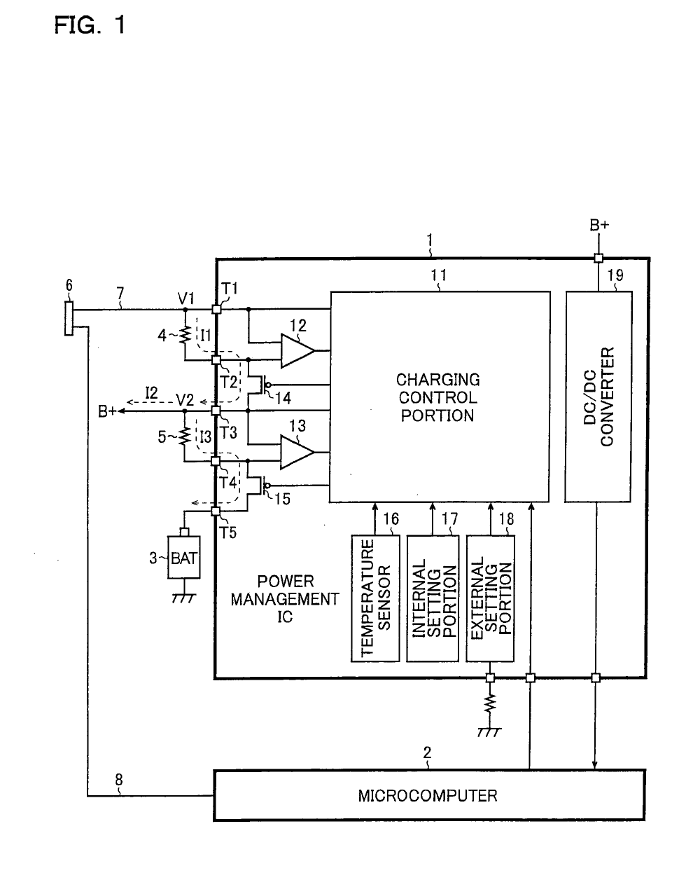

FIG. 1 is a block diagram showing an embodiment of an electronic apparatus (for example, a portable navigation device (PND) or a mobile telephone) incorporating a charging control device according to the present invention.

As shown in FIG. 1, the electronic apparatus of this embodiment includes a power management IC 1, a microcomputer, a lithium ion battery 3, sense resistors 4 and 5, a port 6, a power supply line 7 and a signal line 8.

The power management IC 1 is a charging control device that controls the charging of the lithium ion battery 3. The internal configuration and the operation of the power management IC 1 will be described later.

The microcomputer 2 is information processing means that is driven by receiving power from the power management IC 1, and monitors whether, as a power supply source externally connected to the electronic apparatus, a USB host is connected to the port 6 or a power supply adapter is connected thereto (whether the connection to the USB host through the signal line 8 is achieved), and transmits the result to the charging control portion 11 of the power management IC 1. When the USB host is connected to the port 6, the microcomputer 2 exchanges signals with the USB host through the signal line 8.

With respect the foregoing, a more specific sequence will be described. When a voltage V1 is applied to the power supply line 7, the power management IC 1 is activated. Here, since the type of power supply source externally connected to the electronic apparatus is unclear, the power management IC 1 assumes that the USB host conforming to a low power standard (the upper limit of a supply current I1 is 100 mA) is connected, and starts the control of the charging of the lithium ion battery 3 by using the safest side.

Thereafter, the supply of power from the power management IC 1 to the microcomputer 2 is started, and, when the microcomputer 2 is activated, the microcomputer 2 performs determination processing (for determining the connection of the USB host and the high power/lower power standard) on the USB host.

Here, when the microcomputer 2 determines that the USB host conforming to the high power standard (the upper limit of the supply current I1 is 500 mA) is connected, the microcomputer 2 transmits the determination to the power management IC 1. The power management IC 1 receives it and switches the charging control mode of the lithium ion battery 3 according to the result obtained by the monitoring by the microcomputer 2.

On the other hand, when the microcomputer 2 determines that the USB host conforming to the low power standard is connected, the microcomputer 2 transmits the determination to the power management IC 1. The power management IC 1 receives it and maintains the current charging control mode of the lithium ion battery 3.

When the microcomputer 2 cannot determine the connection of the USB host, the microcomputer 2 recognizes that the power supply adapter is connected, and transmits the recognition to the power management IC 1. The power management IC 1 receives it and switches the charging control mode of the lithium ion battery 3 according to the result obtained by the monitoring by the microcomputer 2.

The lithium ion battery 3 is a secondary battery that is charged and controlled by the power management IC 1, and, when the USB host and the power supply adapter are not connected to the port 6, the lithium ion battery 3 serves as a power supply for driving the electronic apparatus.

The sense resistor 4 is externally connected between a terminal T1 and a terminal T2 of the power management IC 1, and is means for converting the supply current I1 from the USB host or the power supply adapter into a voltage signal.

The sense resistor 5 is externally connected between a terminal T3 and a terminal T4 of the power management IC 1, and is means for converting a charging current I3 (excess current obtained by subtracting a consumption current I2 of a system used for operations other than the charging of the lithium ion battery 3 from the supply current I1 from the USB host or the power supply adapter) for the lithium ion battery 3 into a voltage signal.

The port 6 is interface means for externally connecting the USB host or the power supply adapter to the electronic apparatus.

The power supply line 7 is a line through which power is supplied from the USB host or the power supply adapter connected to the port 6.

The signal line 8 is a line through which the USB host connected to the port 6 and the microcomputer 2 exchange signals with each other.

The internal configuration of the power management IC 1 will now be described in detail.

As shown in FIG. 1, the power management IC 1 includes the charging control portion 11, amplifiers 12 and 13, p-channel field-effect transistors 14 and 15, a temperature sensor 16, an internal setting portion 17, an external setting portion 18 and a DC/DC converter 19.

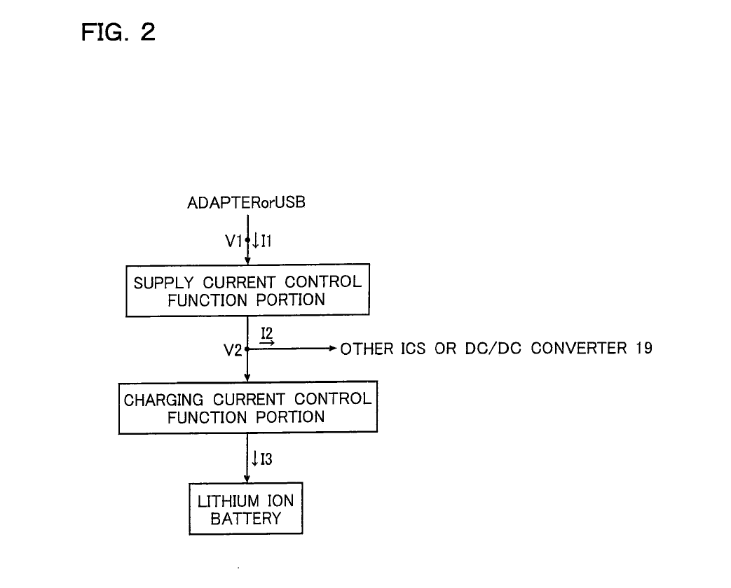

The charging control portion 11 controls the continuity (“on” resistance) of the transistors 14 and 15, and thereby operates as a supply current control function portion and a charging current control function portion as shown in FIG. 2. The operation of the charging control portion 11 will be described later.

The amplifier 12 is means that amplifies a voltage across the sense resistor 4 and that feeds, to the charging control portion 11, a supply current detection signal corresponding to the supply current I1 from the USB host or the power supply adapter.

The amplifier 13 is means that amplifies a voltage across the sense resistor 5 and that feeds, to the charging control portion 11, a charging current detection signal corresponding to the charging current I3 for the lithium ion battery 3.

The transistor 14 is means that is internally connected between the terminal T2 and the terminal T3 and that increases or decreases the current value of the supply current I1 according to the control of the continuity.

The transistor 15 is means that is internally connected between the terminal T4 and the terminal T5 and that increases or decreases the current value of the charging current I3 according to the control of the continuity.

The temperature sensor 16 is means that generates a temperature detection signal Sout corresponding to an ambient temperature T, and that feeds it to the charging control portion 11. The internal configuration and the operation of the temperature sensor 16 will be described in detail later.

The internal setting portion 17 is means that previously sets the target value of the charging current I3 corresponding to the standard (high power/low power) of the USB host, and that feeds the setting value to the charging control portion 11.

The external setting portion 18 is means that uses an external resistor or the like for the user to freely set the target value of the charging current I3, and that feeds the setting value to the charging control portion 11.

The DC/DC converter 19 is means that operates by receiving a voltage V2 obtained at the terminal T3 and that supplies a predetermined drive voltage to the individual circuit portions (the microcomputer 2 in the example of FIG. 1) of the electronic apparatus; as the DC/DC converter 19, a series regulator or a switching regulator can be used.

Although not shown in FIG. 1, the power management IC 1 of this embodiment includes a back gate switching circuit 20 which switches between units connected thereto such that the back gates of the transistors 14 and 15 reach the maximum potential point within the system. The configuration and the operation of the back gate switching circuit 20 will be described in detail later.

The control of the charging of the lithium ion battery 3 by the power management IC 1 (especially the charging control portion 11) will now be described in detail.

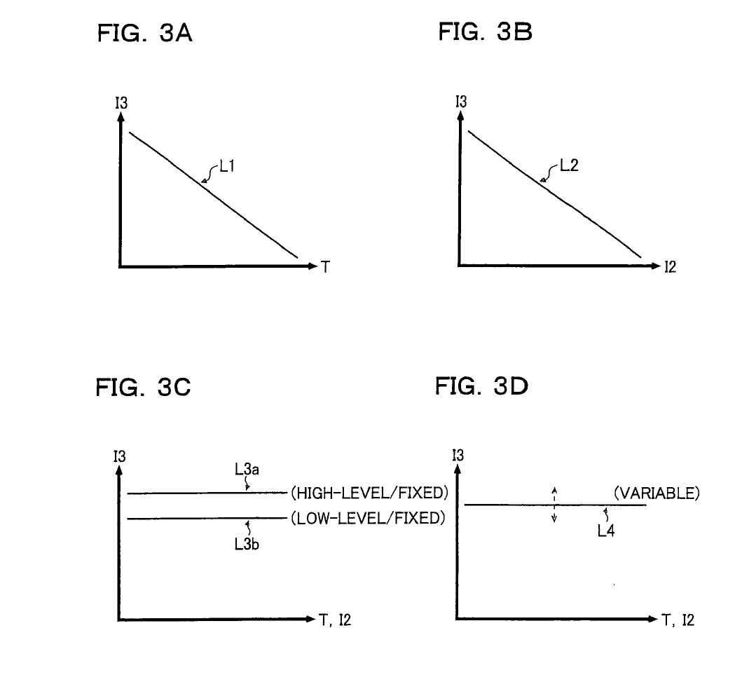

FIGS. 3A to 3D are diagrams for respectively describing the control of the charging corresponding to the ambient temperature T, the control of the charging corresponding to the system current I2, the control of the charging corresponding to the internal setting value and the control of the charging corresponding to the external setting value.

As shown in a solid line L1 in FIG. 3A, the charging control portion 11 controls, based on the temperature detection signal Sout obtained by the temperature sensor 16, the charging of the lithium ion battery 3 such that, as the ambient temperature T is higher, the target value of the charging current I3 is decreased.

As shown in a solid line L2 in FIG. 3B, the charging control portion 11 detects the consumption current I2 of the system from the potential difference between a terminal voltage V1 obtained at the terminal T1 and a terminal voltage V2 obtained at the terminal T3, and controls the charging of the lithium ion battery 3 such that, as this current value is higher, the target value of the charging current I3 is decreased.

As shown in solid lines L3a and L3b in FIG. 3C, the charging control portion 11 controls, based on the target value (fixed value) of the charging current I3 previously set by the internal setting portion 17, the charging of the lithium ion battery 3 corresponding to the standard (high power/low power) of the USB host.

As shown in a solid line IA in FIG. 3D, the charging control portion 11 controls, based on the target value (variable value) of a charging current I4 freely set by the external setting portion 18, the charging of the lithium ion battery 3.

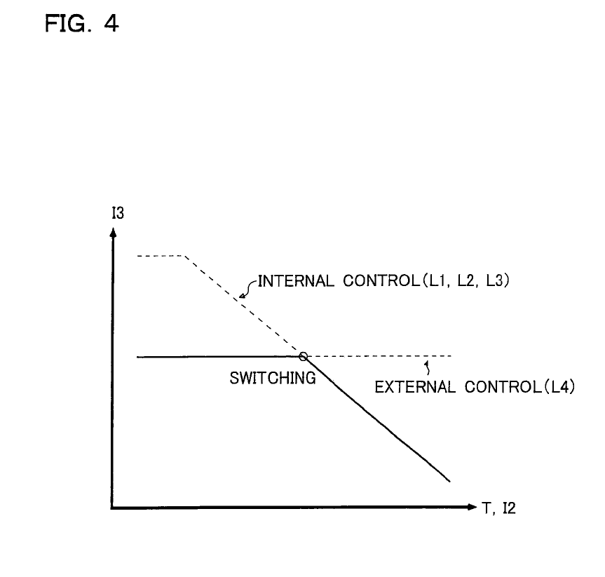

The feature of the present invention is not that the control of the charging shown in FIGS. 3A to 3D is individually performed, but that, as shown in FIG. 4, as the target value of the charging current I3, the smallest value among the target values (see the solid line L1 in FIG. 3A, the solid line L2 in FIG. 3B and the solid lines L3a and L3b in FIG. 3C) previously set within the device and the target value (see the solid line L4 in FIG. 3D) freely set from the outside of the device is selected, and that the charging current I3 is controlled to be within an allowable consumption power and thus the lithium ion battery 3 is prevented from being overloaded.

With this type of configuration, even when the external setting value (L4) is set high, if for example, the current value of the charging current I3 is reduced due to the increased ambient temperature T or the increased system current I2, the setting values (L1 and L2) thereof are preferentially applied, with the result that the charging can be safely continued. On the other hand, if such a situation is not encountered, a large charging current I3 is set as the external setting value (L4), and thus it is possible to reduce the charging time.

Conventionally, when the USB is used, the upper limit (L3a and L3b) of the charging current I3 is set in a fixed manner. Hence, even if the user determines that it is dangerous to perform the charging on condition of such an upper limit, it is impossible to change the setting. On the other hand, in the present invention, when the external setting value (IA) is set lower than the internal setting value (L3a and L3b), it is possible to freely lower the upper limit of the current at the time of use of the USB.

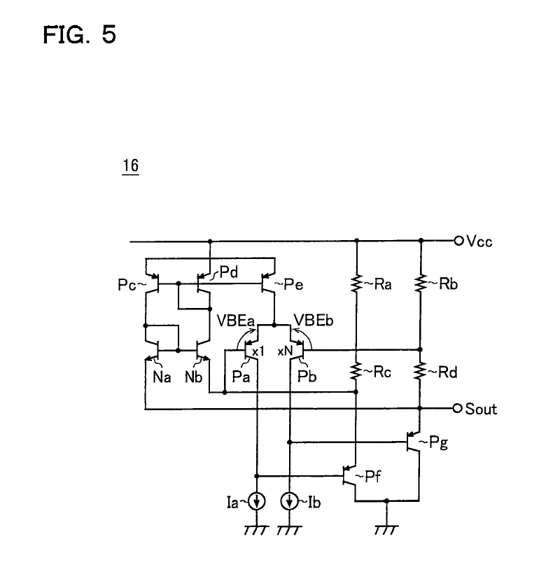

The configuration and the operation of the temperature sensor 16 will now be described in detail with reference to FIG. 5.

FIG. 5 is a circuit diagram showing an example of the configuration of the temperature sensor 16.

The temperature sensor 16 of this configuration example includes a pair of PNP bipolar transistors Pa and Pb (in this configuration example, the ratio of the emitter area is 1:N) that are operated at different emitter current densities JEa and JEb, and produces an oppositely varying temperature detection signal Sout by utilizing the fact that a differential voltage AVF (=VBE1−VBE2) between the base-emitter voltages VBE1 and VBE2 of the transistors Pa and Pb varies with the ambient temperature T. As other constituent components, the temperature sensor 16 includes PNP bipolar transistors Pc to Pg, NPN bipolar transistors Na and Nb, constant current sources Ia and Ib and resistors Ra to Rd.

The collectors of the transistors Pa and Pb are connected to ground through the constant current sources Ia and Ib, respectively. The emitters of the transistors Pa and Pb are connected to the collector of the transistor Pe. The emitters of the transistors Pc to Pe are connected to a terminal to which a power supply voltage Vcc is input. The bases of the transistors Pc to Pe are connected to the collector of the transistor Pd. The collector of the transistor Pc is connected to the collector of the transistor Na. The collector of the transistor Pd is connected to the collector of the transistor Nb. The bases of the transistors Na and Nb are connected to the collector of the transistor Na. The emitter of the transistor Na is connected to a terminal to which the temperature detection signal Sout is output. The emitter of the transistor Nb is connected to the base of the transistor Pa. The emitter of the transistor Pf is connected to the base of the transistor Pa and is also connected through the resistors Rc and Ra to the power supply voltage Vcc input terminal. The collector of the transistor Pf is connected to ground. The base of the transistor Pf is connected to the collector of the transistor Pa. The emitter of the transistor Pg is connected through the resistors Rd and Rb to the power supply voltage Vcc input terminal. The node between the resistors Rb and Rd is connected to the base of the transistor Pb. The collector of the transistor Pg is connected to ground. The base of the transistor Pg is connected to the collector of the transistor Pb.

In the temperature sensor 16 configured as described above, feedback control (so-called common mode feedback control) is performed on the collector voltages and the emitter currents of the transistors Pa and Pb such that the emitter currents of the transistors Na and Nb are equal to each other. Consequently, the voltage level of the temperature detection signal Sout generated by the temperature sensor 16 is given by equation (1) below.

$$[ Equation 1 ]$$

$$Sout = Vcc - \frac{Rb + Rd}{Rd} \cdot Δ VF \qquad ( 1 )$$

The differential voltage ΔVF included in equation (1) is expressed by equation (2) below based on a diode equation.

$$[ Equation 2 ]$$

$$\begin{matrix}Δ VF = VBEa - VBEb \\ = \frac{kT}{q} ln ( JEa ) - \frac{kT}{q} ln ( JEb ) \\ = \frac{kT}{q} ln ( \frac{JEa}{JEb} ) \\ = \frac{kT}{q} ln ( N )\end{matrix} \qquad ( 2 )$$

In equation (2) above, k represents Boltzmann's constant, T represents the ambient temperature (absolute temperature), q represents the charge amount of an electron and JEa and JEb represent the emitter current densities of the transistors Pa and Pb, respectively.

As is obvious from equation (2) above, the differential voltage AVF between the base-emitter voltages VBEa and VBEb of the pair of transistors Pa and Pb that are operated at the different emitter current densities JEa and JEb varies with the ambient temperature T

Thus, the voltage level of the temperature detection signal Sout is expressed by equation (3) below given by equations (1) and (2), and oppositely varies with the ambient temperature T.

$$[ Equation 3 ]$$

$$\begin{matrix}Sout = Vcc - \frac{Rb + Rd}{Rd} \cdot \frac{kT}{q} ln ( N ) \\ = Vcc - α \cdot T\end{matrix} \qquad ( 3 )$$

As described above, the temperature sensor 16 of this configuration example uses not NPN bipolar transistors but the PNP bipolar transistors Pa and Pb, and thereby generates the temperature detection signal Sout that oppositely varies with the ambient temperature T.

With this configuration, unlike a conventional configuration where a positively varying temperature detection signal is generated by using NPN bipolar transistors, where the logic state thereof is inverted and where thus the oppositely varying characteristic is achieved, it is possible to directly use the temperature detection signal Sout to control the charging of the lithium ion battery 3 without considering the offset of an inversion amplifier and the temperature characteristics. Thus, it is possible to highly accurately control the charging according to the ambient temperature T. Moreover, since it is unnecessary to provide the inversion amplifier, it is possible to reduce the area of the temperature sensor 16 and the consumption power.

In particular, in the power management IC 1, which controls the charging of the lithium ion battery 3, since high absolute accuracy is required on the detection of the ambient temperature T, the temperature sensor 16 is preferably configured as described above.

In the temperature sensor 16 configured as described above, it is preferable to obtain a sufficient degree of pairing between the transistors Pc and Pd, between the transistors Na and Nb and between the transistors Pf and Pg. With this type of configuration, since the collector voltages of the transistors Pa and Pb are unlikely to be affected by voltage variations, it is possible to stably detect the temperature.

The temperature sensor 16 configured as described above has not only a path through which to draw, as the emitter current of the transistor Pf, a current from the emitter of the transistor Nb but also a path through which to draw a current from the power supply voltage Vcc input terminal via the resistors Ra and Rc equal in resistance to the resistors Rb and Rd. With the configuration having these types of paths, since error factors for the current flowing into the emitters of the transistors Pf and Pg can be eliminated, it is possible to highly accurately and linearly detect the ambient temperature T. If emphasis is placed on the size reduction of the chip, the above paths can be removed.

In the temperature sensor 16 configured as described above, the resistances of the resistors Ra to Rd can be adjusted by laser trimming or the like. With this type of configuration, even after the formation of the circuit, it is possible to freely adjust the degree of dependence of the temperature detection signal Sout on the ambient temperature T.

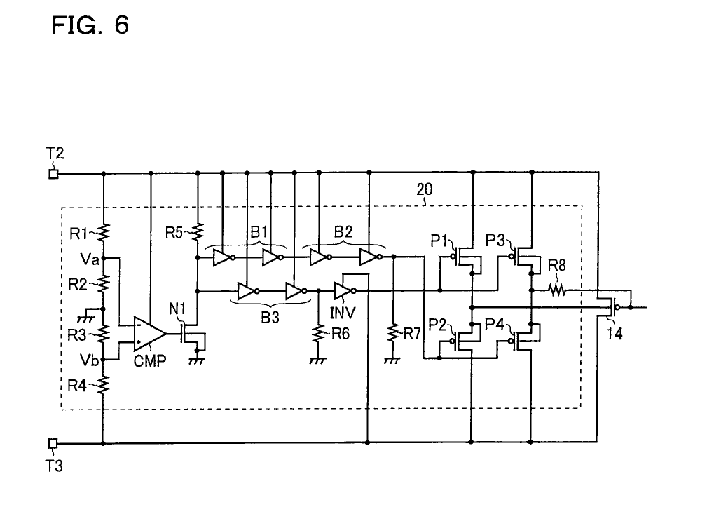

The configuration and the operation of the back gate switching circuit 20 will now be described in detail with reference to FIG. 6.

FIG. 6 is a circuit diagram showing an example of the configuration of the back gate switching circuit 20. With reference to this figure, a configuration where the back gate of the transistor 14 inserted between the terminals T2 and T3 is switched will be described; the same configuration can be employed when the transistor 15 connected between the terminals T4 and T5 is switched.

As shown in FIG. 6, the back gate switching circuit 20 of this configuration example includes p-channel field-effect transistors P1 to P4, an n-channel field-effect transistor N1, resistors R1 to R8, a comparator CMP, an inverter INV and buffers B1 to B3.

The drain of the transistor P1 is connected to the terminal T2. The source of the transistor P1 is connected to the back gate of the transistor 14. The back gate of the transistor P1 is connected to the source thereof. The drain of the transistor P2 is connected to the terminal T3. The source of the transistor P2 is connected to the back gate of the transistor 14. The back gate of the transistor P2 is connected to the source thereof.

The drain of the transistor P3 is connected to the terminal T2. The source of the transistor P3 is connected through the resistor R8 to the gate of the transistor 14. The back gate of the transistor P3 is connected to the source thereof. The drain of the transistor P4 is connected to the terminal T3. The source of the transistor P4 is connected through the resistor R8 to the gate of the transistor 14. The back gate of the transistor P4 is connected to the source thereof.

The resistors R1 and R2 are connected in series between the terminal T2 and the ground terminal. The resistors R3 and R4 are connected in series between the terminal T3 and the ground terminal. The inverting input terminal (−) of the comparator CMP is connected to the node (terminal through which to draw a division voltage Va) between the resistors R1 and R2. The non-inverting input terminal (+) of the comparator CAP is connected to the node (terminal through which to draw a division voltage Vb) between the resistors R3 and R4. The power supply terminal of the comparator CMP is connected to the terminal T2. The drain of the transistor N1 is connected through the resistor R5 to the terminal T2. The source of the transistor N1 is connected to ground. The gate of the transistor N1 is connected to the output terminal of the comparator CMP. The back gate of the transistor N1 is connected to the source thereof.

Specifically, in the back gate switching circuit 20 of this configuration example, a comparison portion is formed with the comparator CMP, the resistors R1 to R5 and the transistor N1, and receives power from the terminal T2 to become driven. The comparison portion compares the division voltage Va with the division voltage Vb (hence, a voltage input to the terminal T2 with a voltage input to the terminal T3), and produces, when the former is higher than the latter, a high-level comparison signal and produces, when the former is lower than the latter, a low-level comparison signal.

The drain (terminal from which the comparison signal is output) of the transistor N1 is connected through the buffers B1 and B2 to the gates of the transistors P2 and P4, and is also connected through the buffer B3 and the inverter INV to the gates of the transistors P1 and P3. The power supply terminals of the buffers B1 to B3 are connected to the terminal T2. On the other hand, the power supply terminal of the inverter INV is connected to the terminal T3.

As described above, the inverter INV receives power from the terminal T3 to become driven. This is not only because, when the terminal T3 is higher in potential than the terminal T2, in order for the transistors P1 and P3 to be reliably turned off, it is necessary to increase the potential of the gates of the transistors P1 and P3 up to the potential of the terminal T3, but also because, even when the terminal T2 is open, the gates of the transistors P1 and P3 are reliably turned high.

The buffer B2 also receives power from the terminal T2 to become driven. By contrast, this is not only because, when the terminal T2 is higher in potential than the terminal T3, in order for the transistors P2 and P4 to be reliably turned off, it is necessary to increase the potential of the gates of the transistors P2 and P4 up to the potential of the terminal T2, but also because, even when the terminal T3 is open, the gates of the transistors P2 and P4 are reliably turned high.

The resistor R6 is connected between the input terminal of the inverter INV and the ground terminal. The resistor R7 is connected between the gates of the transistors P2 and P4 and the ground terminal.

The operation of the back gate switching circuit 20 configured as described above will now be described in detail.

The case where the voltage input to the terminal T2 is higher than the voltage input to the terminal T3 (where the division voltage Va is higher than the division voltage Vb) will first be described. In this case, the output of the comparator CMP is low, and thus the transistor N1 is turned off. Hence, the comparison signal output from the drain of the transistor N1 is high through the resistor R5.

Here, the inverted comparison signal produced by the inverter INV is low, and thus the transistors P1 and P3 are turned on. On the other hand, a high-level (voltage level equal to the voltage input to the terminal T2) comparison signal is input through the buffers B1 and B2 to the transistors P2 and P4, and thus the transistors P2 and P4 are turned off. Consequently, the back gate and the gate of the transistor 14 are increased to the maximum potential point within the system at the terminal T2, and the parasitic diode present between the back gate and the source of the transistor 14 is reverse-biased, with the result that it is possible not only to interrupt the current leak path from the terminal T2 to the terminal T3 but also to reliably turn off the transistor 14.

When the terminal T3 is open, whether or not the inverted comparison signal produced by the inverter INV is high is unpredictable. In this case, as the inverted comparison signal, a low-level signal is output, and hence no particular problem is not encountered.

The case where the voltage input to the terminal T2 is lower than the voltage input to the terminal T3 (where the division voltage Va is lower than the division voltage Vb) will now be described. In this case, the output of the comparator CMP is high, and thus the transistor N1 is turned on. Hence, the comparison signal output from the drain of the transistor N1 is low.

Here, the inverted comparison signal produced by the inverter INV is high (voltage level equal to the voltage input to the terminal T3), and thus the transistors P1 and P3 are turned off. On the other hand, a low-level comparison signal is input to the transistors P2 and P4 through the buffers B1 and B2, and thus the transistors P2 and P4 are turned on. Consequently, the back gate and the gate of the transistor 14 are increased to the maximum potential point within the system at the terminal T3, and the parasitic diode present between the back gate and the drain of the transistor 14 is reverse-biased, with the result that it is possible not only to interrupt the current leak path from the terminal T3 to the terminal T2 but also to reliably turn off the transistor 14.

When the terminal T2 is open, the logic states of outputs from the comparator CMP and the buffers B1 to B3 are unpredictable. With the back gate switching circuit 20 of this comparison example, however, the input terminal of the inverter INV is pulled down to the ground terminal through the resistor R6, and the gates of the transistors P2 and P4 are pulled down to the ground terminal through the resistor R7. With these types of resistors R6 and R7, even when the terminal T2 is open, it is possible not only to reliably turn off the transistors P1 and P3 but also to reliably turn on the transistors P2 and P4.

As described above, the back gate switching circuit 20 of this comparison example includes: the comparison portion (CMP, R1 to R5 and N1) that receives power from the terminal T2 to become driven, that compares the voltage input to the terminal T2 with the voltage input to the terminal T3, and that produces, when the former is higher than the latter, the high-level comparison signal and produces, when the former is lower than the latter, the low-level comparison signal; the inverter INV that receives power from the terminal T3 to become driven, and that inverts the logic state of the comparison signal input from the comparison portion through the buffer B3 to produce the inverted comparison signal; the transistor P1 that is connected between the back gate of the transistor 14 and the terminal T2 and that is turned on and off according to the inverted comparison signal; the transistor P2 that is connected between the back gate of the transistor 14 and the terminal T2 and that is turned on and off according to the comparison signal input from the comparison portion through the buffers B1 and B2; the transistor P3 that is connected between the gate of the transistor 14 and the terminal T2 and that is turned on and off according to the inverted comparison signal; the transistor P4 that is connected between the gate of the transistor 14 and the terminal T3 and that is turned on and off according to the comparison signal input from the comparison portion through the buffers B1 and B2; and the resistors R6 and R7 that pull down the input terminal of the inverter INV and the gates of the transistors P2 and P4.

With this type of configuration, even when it is unpredictable which of the source and the drain of the transistor 14 is high in potential, the back gate and the gate thereof are connected to the maximum potential point within the system, and thus it is possible not only to interrupt the unnecessary current leak path in the transistor 14 but also to reliably turn off the transistor 14.

With the back gate switching circuit 20 configured as described above, even when one of the terminals T2 and T3 becomes open, it is possible to properly switch between the units to which the back gate and the gate of the transistor 14 are connected without any problem.

Among circuit components that constitute the back gate switching circuit 20 of FIG. 6, the buffers B1 to B3 are not necessarily required, and hence they may be omitted as appropriate. When all the buffers B1 to B3 are omitted, the pull down resistors R6 and R7 can be integrally formed.

When n-channel field-effect transistors are used instead of the p-channel field-effect transistors 14 and 15, the back gate and the gate thereof are turned high, and thus it is possible to reliably and fully turn them on.

Although the above description deals with the case where, as the means for switching the back gates of the p-channel field-effect transistors 14 and 15 of the power management IC 1, the back gate switching circuit 20 configured as described above is used, the back gate switching circuit 20 is not limited to this application. The back gate switching circuit 20 can be widely applied to systems in general where it is unpredictable which of the source and the drain of the field-effect transistor is high in potential.

That is, in the systems where it is unpredictable which of the source and the drain of the field-effect transistor is high in potential, the back gate switching circuit 20 configured as described above is a useful technology for reliably interrupting the current leak path of the field-effect transistor. For example, such a technology is one that is suitable for use in a charging control device that controls the charging of a secondary battery.

Although the above embodiment deals with the case where the lithium ion battery is used as the secondary battery, the present invention is not limited to this configuration. Any other type of secondary battery may be used instead.

In addition to the above embodiment, in the present invention, many modifications are possible without departing from the sprit of the present invention.

### INDUSTRIAL APPLICABILITY

The present invention is a useful technology for enhancing both the safety of a charging control device that controls the charging of a secondary battery and the charging performance thereof.

1. A charging control device arranged to monitor a charging current for a secondary battery and to control charging of the secondary battery such that a current value of the charging current is equal to whichever of a target value preset within the device and a target value freely set from outside the device is smaller.

2. The charging control device of claim 1, arranged such that at least a target value corresponding to an ambient temperature, a target value corresponding to a consumption current of a system and a target value corresponding to a standard of an externally connected power supply source are preset within the device, and the charging of the secondary battery is controlled such that the current value of the charging current is equal to whichever of the target values preset within the device and the target value freely set from outside the device is smaller.

3. The charging control device of claim 2 arranged such that the target value corresponding to the ambient temperature is set such that, as the ambient temperature is higher, the target value corresponding to the ambient temperature is decreased.

4. The charging control device of claim 3 comprising a temperature sensor to detect the ambient temperature, wherein the temperature sensor includes a pair of PNP bipolar transistors that are operated at different emitter current densities, and arranged to produce an oppositely varying temperature detection signal by utilizing a fact that a difference between base-emitter voltages of the transistors varies with the ambient temperature.

5. An electronic apparatus comprising:
a secondary battery; and
the charging control device of claim 1,
wherein charging of the secondary battery is controlled by the charging control device.

6. An electronic apparatus comprising:
a secondary battery; and
the charging control device of claim 2,
wherein charging of the secondary battery is controlled by the charging control device.

7. An electronic apparatus comprising:
a secondary battery; and
the charging control device of claim 3,
wherein charging of the secondary battery is controlled by the charging control device.

8. An electronic apparatus comprising:
a secondary battery; and
the charging control device of claim 4,
wherein charging of the secondary battery is controlled by the charging control device.
